(19) United States
(12) Patent Application Publication
(10) Pub. No.: US 2024/0386339 A1
(43) Pub. Date: Nov. 21, 2024

(54) Accelerated Test Data Analysis Method And Apparatus Based On Gray Forecast Model, And Device

(71) Applicant: China Electronic Product Reliability and Environmental Testing Research Institute, Guangdong (CN)

(72) Inventors: Guangze Pan, Guangdong (CN); Dan Li, Guangdong (CN); Bochen Chen, Guangdong (CN); Lijun Sun, Guangdong (CN); Yuanhang Wang, Guangdong (CN); Wenwei Liu, Guangdong (CN); Jianfeng Yang, Guangdong (CN); Xiaojian Ding, Guangdong (CN)

(73) Assignee: China Electronic Product Reliability and Environmoental Testing Research Institute, Guangdong (CN)

(21) Appl. No.: 18/587,197

(22) Filed: Feb. 26, 2024

(30) Foreign Application Priority Data
May 8, 2023 (CN) 202310505507.1

(51) Int. Cl. G06Q 10/04

(52) U.S. Cl. CPC G06Q 10/04

(57) ABSTRACT

Disclosed are an accelerated test data analysis method and apparatus based on a grey forecast model, a device. The method includes: acquiring an actual test performance value of a to-be-tested product at each test moment during the accelerated test of the to-be-tested product under a first stress condition; determining a performance degradation forecast function of the to-be-tested product according to the actual test performance value of the to-be-tested product at each test moment based on the gray forecast model; forecasting a forecasted performance value of the to-be-tested product at each test moment based on the performance degradation forecast function; determining a forecast deviation value of the to-be-tested product at each test moment according to a difference value between the actual test performance value and the forecasted performance value of the to-be-tested product at each test moment; determining a deviation forecast function; determining performance degradation failure time of the to-be-tested product.

### CROSS REFERENCE TO RELATED APPLICATION

The present application claims priority to Chinese Patent Application with No. 202310505507.1, entitled “Accelerated Test Data Analysis Method and Apparatus Based on Gray Forecast Model, and Device”, and filed on May 8, 2023, the content of which is expressly incorporated herein by reference in its entirety.

### TECHNICAL FIELD

The present disclosure relates to the field of test technology, and more particularly to an accelerated test data analysis method and apparatus and apparatus based on a grey forecast model, and a device.

### BACKGROUND

The accelerated test is a reliability test under more severe environmental stress conditions than the normal working environmental stress of a product, in order to quickly evaluate a reliability index and a service life index of the product in a short time. The accelerated test is more efficient and less expensive than the conventional reliability statistical test, and therefore is widely applied to the evaluation of the product reliability and service life.

However, as the product quality and reliability level become higher and higher, the performance degradation data of the product in the accelerated test process become less and less, which affects the analysis accuracy of the accelerated test data, and brings some difficulties to the evaluation of the reliability and the service life of the product. Therefore, improvement is urgently needed.

### SUMMARY

In view of the above, as for the above technical problem, it is necessary to provide an accelerated test data analysis method and apparatus based on a grey forecast model, and a device capable of improving the accuracy of the accelerated test data analysis.

In the first aspect of the present disclosure, an accelerated test data analysis method based on a grey forecast model is provided, including: acquiring an actual test performance value of a to-be-tested product at each test moment during the accelerated test of the to-be-tested product under a first stress condition; determining a performance degradation forecast function of the to-be-tested product according to the actual test performance value of the to-be-tested product at each test moment based on the gray forecast model; forecasting a forecasted performance value of the to-be-tested product at each test moment based on the performance degradation forecast function; determining a forecast deviation value of the to-be-tested product at each test moment according to a difference value between the actual test performance value and the forecasted performance value of the to-be-tested product at each test moment; determining a deviation forecast function according to the forecast deviation value of the to-be-tested product at each test moment based on the grey forecast model; correcting the performance degradation forecast function by using the deviation forecast function; and determining performance degradation failure time of the to-be-tested product based on the corrected performance degradation forecast function and a performance degradation failure threshold value of the to-be-tested product.

In an embodiment, the determining the performance degradation forecast function of the to-be-tested product according to the actual test performance value of the to-be-tested product at each test moment based on the gray forecast model includes: performing an accumulation calculation on an actual test performance value of the to-be-tested product at a test moment and actual test performance values of the to-be-tested product at other test moments before the test moment according to the grey forecast model, to obtain a performance transformation value of the to-be-tested product at the test moment; determining a value of an unknown parameter in an initial performance degradation forecast function according to the performance transformation value and the actual test performance value of the to-be-tested product at each test moment, and obtaining the performance degradation forecast function of the to-be-tested product.

In an embodiment, the determining the deviation forecast function according to the forecast deviation value of the to-be-tested product at each test moment based on the grey forecast model includes: performing an accumulation calculation on a forecast deviation value of the to-be-tested product at a test moment and forecast deviation values of the to-be-tested product at other test moments before the test moment according to the grey forecast model, to obtain a deviation transformation value of the to-be-tested product at the test time; determining a value of an unknown parameter in the initial deviation forecast function according to the forecast deviation value and the deviation transformation value of the to-be-tested product at each test moment, and obtaining the performance degradation forecast function of the to-be-tested product.

In an embodiment, the method may further include: determining a characteristic lifetime of the to-be-tested product under a target stress condition based on a general target acceleration model corresponding to the to-be-tested product; determining a reliability function of the to-be-tested product under the target stress condition based on the characteristic lifetime; determining a reliability curve of the to-be-tested product based on the reliability function of the to-be-tested product under the target stress condition.

In an embodiment, the method may further include: acquiring a stress magnitude of a reference product under each accelerated test during the accelerated test on the reference product under at least two different second stress conditions, wherein the reference product is of the same type as the to-be-tested product; acquiring an initial general acceleration model corresponding to the reference product, wherein the initial general acceleration model includes a parameter to be solved; solving the parameter to be solved in the initial general acceleration model based on the initial general acceleration model, the stress magnitude of the reference product under each accelerated test, and a type of the lifetime distribution function, and obtaining the target general acceleration model.

In an embodiment, the acquiring the initial general acceleration model corresponding to the reference product includes: determining the initial general acceleration model from candidate general acceleration models according to a stress type of each second stress condition.

In an embodiment, the method may further include: determining an average lifetime of the to-be-tested product based on the characteristic lifetime and the type of the lifetime distribution function.

In the second aspect of the present disclosure, an accelerated test data analysis apparatus based on a grey forecast model is provided, including: a test module, configured to acquire an actual test performance value of a to-be-tested product at each test moment during the accelerated test of the to-be-tested product under a first stress condition; a forecast function building module, configured to determine a performance degradation forecast function of the to-be-tested product according to the actual test performance value of the to-be-tested product at each test moment based on the gray forecast model; a forecast module, configured to predict a forecasted performance value of the to-be-tested product at each test moment based on the performance degradation forecast function; a deviation calculation module, configured to determine a forecast deviation value of the to-be-tested product at each test moment according to a difference value between the actual test performance value and the forecasted performance value of the to-be-tested product at each test moment; a deviation function building module, configured to determine a deviation forecast function according to the forecast deviation value of the to-be-tested product at each test moment based on the grey forecast model; a correction module, configured to correct the performance degradation forecast function by using the deviation forecast function; an analysis module, configured to determine performance degradation failure time of the to-be-tested product based on the corrected performance degradation forecast function and a performance degradation failure threshold value of the to-be-tested product.

In the third aspect of the present disclosure, a computer device is provided, including a processor and a memory storing a computer program, the processor, when executing the computer program, implements the steps of: acquiring an actual test performance value of a to-be-tested product at each test moment during the accelerated test of the to-be-tested product under a first stress condition; determining a performance degradation forecast function of the to-be-tested product according to the actual test performance value of the to-be-tested product at each test moment based on the gray forecast model; forecasting a forecasted performance value of the to-be-tested product at each test moment based on the performance degradation forecast function; determining a forecast deviation value of the to-be-tested product at each test moment according to a difference value between the actual test performance value and the forecasted performance value of the to-be-tested product at each test moment; determining a deviation forecast function according to the forecast deviation value of the to-be-tested product at each test moment based on the grey forecast model; correcting the performance degradation forecast function by using the deviation forecast function; and determining performance degradation failure time of the to-be-tested product based on the corrected performance degradation forecast function and a performance degradation failure threshold value of the to-be-tested product.

In the fourth aspect of the present disclosure, a computer-readable storage medium is provided, on which a computer program is stored, the computer program, when executed by a processor, causes the processor to implement the steps of: acquiring an actual test performance value of a to-be-tested product at each test moment during the accelerated test of the to-be-tested product under a first stress condition; determining a performance degradation forecast function of the to-be-tested product according to the actual test performance value of the to-be-tested product at each test moment based on the gray forecast model; forecasting a forecasted performance value of the to-be-tested product at each test moment based on the performance degradation forecast function; determining a forecast deviation value of the to-be-tested product at each test moment according to a difference value between the actual test performance value and the forecasted performance value of the to-be-tested product at each test moment; determining a deviation forecast function according to the forecast deviation value of the to-be-tested product at each test moment based on the grey forecast model; correcting the performance degradation forecast function by using the deviation forecast function; and determining performance degradation failure time of the to-be-tested product based on the corrected performance degradation forecast function and a performance degradation failure threshold value of the to-be-tested product.

In the accelerated test data analysis method and apparatus based on the grey forecast model, computer device and the storage medium, the performance degradation forecast function and the deviation forecast function of the to-be-tested product are constructed through the gray forecast model, in order to accurately analyze the small sample test data (the actual test performance value and forecasted deviation value). In addition, after the forecasted performance value of the to-be-tested product at each test moment is forecasted, the difference value between the actual test performance value and the forecasted performance value of the to-be-tested product at each test moment is further analyzed to determine the deviation forecast function; and the performance degradation forecast function is corrected by using the deviation forecast function, thereby further improving the accuracy of the performance forecast analysis of the to-be-tested product.

### BRIEF DESCRIPTION OF THE DRAWINGS

FIG. 1 is a flow chart showing an accelerated test data analysis method based on a grey forecast model according to an embodiment.

FIG. 2 is a flow chart for determining a reliability curve of a product to be tested according to an embodiment.

FIG. 3 is a flow chart for determining a general target acceleration model according to an embodiment.

FIG. 4 is a schematic diagram of a reliability curve according to an embodiment.

FIG. 5 is a schematic structure diagram illustrating an accelerated test data analysis apparatus based on a gray forecast model according to an embodiment.

FIG. 6 is an internal structure diagram of a computer device according to an embodiment.

### DETAILED DESCRIPTION

In order to make the objects, technical solution, and advantages of the present disclosure clearer, the present disclosure will be elaborated below with reference to the accompanying drawings and embodiments. It should be appreciated that the specific embodiments described herein are merely illustrative of the present disclosure and are not intended to limit the present disclosure.

The accelerated test is a reliability test in which an environmental stress which is more severe than the normal working environmental stress of a product is used for carrying out the test in order to quickly evaluate a reliability index and a service life index of the product in a short time. The accelerated test is more efficient and less expensive than the conventional reliability statistical test, and therefore is widely applied to the evaluation of the product reliability and service life. However, as the product quality and reliability level become higher and higher, the performance degradation data of the product in the accelerated test process becomes less and less, which brings some difficulties to the evaluation of the reliability and the service life of the product. At present, for the reliability and service life evaluation of a product with a high reliability, a long service life, small samples, and a small amount of performance degradation data in the test process, an evaluation method based on a grey forecast model is generally employed.

Since the gray forecast model can accumulate and generate the performance degradation data, analyze the performance degradation law, and predict the failure time of the product, the accelerated test data analysis method based on the gray forecast model is widely used.

However, the existing accelerated test data analysis methods based on the gray forecast model have the following disadvantages: (1) when the gray forecast model is established, only initial data is analyzed, a performance degradation forecast function is established to obtain the performance degradation forecast data, no further analysis is performed on the forecast data and the initial data, and the forecast function is corrected to obtain more accurate performance degradation forecast data, so that the evaluation accuracies of these methods are low; (2) when an acceleration model is established, a single-stress acceleration model or a plurality of independent stress acceleration models are often used, and a non-independent case of a plurality of acceleration stresses is not considered, which has a certain deviation from the actual use of the product, so that the evaluation accuracies of these methods are low and the application ranges thereof are limited.

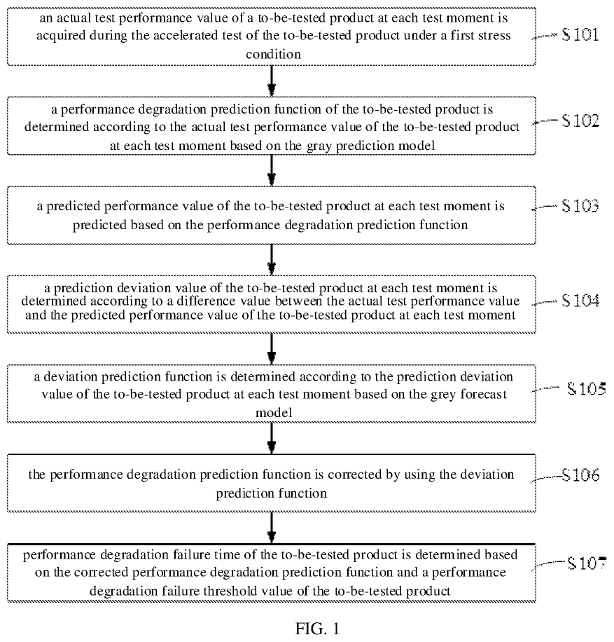

As shown in FIG. 1, in the present embodiment, an accelerated test data analysis method based on a gray forecast model is provided, which is applied to a computer device as an example for illustration, and the method may include the following steps.
S101: an actual test performance value of a to-be-tested product at each test moment is acquired during the accelerated test of the to-be-tested product under a first stress condition.

Specifically, the accelerated test is performed under the first stress condition. The time course is as follows: the performance test is performed on the to-be-tested product at equal intervals A t, and the actual test performance values of m tests are respectively A₁, A₂, A₃, . . . , A_{d}, . . . , Aₘ, d=1, 2, . . . , m.
S102: a performance degradation forecast function of the to-be-tested product is determined according to the actual test performance value of the to-be-tested product at each test moment based on the gray forecast model.

It should be appreciated that the grey forecast model indicates a forecast method in which a mathematical model is established by a small amount of incomplete information to make a forecast; the grey forecast model is an effective tool for dealing with a small sample forecast problem.

A system with completely undetermined information is a black system, and a system with completely determined information is a white system, and a gray system is between the black system and the white system, i.e., a part of the information is known, the other part of the information is unknown, and there exists an uncertain relationship among factors in the system. According to the grey system theory, although the objective appearance is complex, it always has the whole function, so that there definitely exists an inherent law. The key is how to choose an appropriate manner to mine and utilize it. The grey system seeks a variation law of original data by disposing the original data, which is a way to seek the realization law of data from the data, that is, the production of a grey sequence, all grey sequences can weaken randomness thereof by some kind of generation, and show a regularity thereof.

In the present embodiment, a gray sequence corresponding to an actual test performance value is generated according to the gray forecast model to find the regularity of the actual test performance values at various test moments; and the performance degradation forecast function of the to-be-tested product is determined according to the gray sequence and the actual test performance values of the to-be-tested product at the various test moments.

Specifically, the performance degradation forecast function in the embodiment is shown in the following formula (1):

$$y ( t ) = ( {A}_{1} - q / p ) \times exp [ - p ( t / Δ t - 1 ) ] + q / p , \qquad ( 1 )$$

where y(t) represents the performance degradation forecast function, i.e., a product performance parameter forecast value at a moment t; p and q are unknown parameters.
S103: a forecasted performance value of the to-be-tested product at each test moment is forecasted based on the performance degradation forecast function.

Specifically, the above-mentioned m test moments t1, t2, t3, . . . , tm are substituted into the formula (1) to obtain m forecasted performance values, i.e., A′₁, A′₂, A′₃, A′₄, . . . , A′m.
S104: a forecast deviation value of the to-be-tested product at each test moment is determined according to a difference value between the actual test performance value and the forecasted performance value of the to-be-tested product at each test moment.

The difference value between the actual test performance value and the forecasted performance value at each test moment is calculated. As an example, the difference value between the actual test performance value A₁ and the forecasted performance value A′₁ is denoted as C1.
S105: a deviation forecast function is determined according to the forecast deviation value of the to-be-tested product at each test moment based on the grey forecast model.

Specifically, a gray sequence corresponding to the forecast deviation value is generated according to the gray forecast model to find the regularity of the forecast deviation values at various test moments; and the deviation forecast function is determined according to the gray sequence and the forecast deviation value of the to-be-tested product at each test moment.

Specifically, the deviation forecast function in the present embodiment is shown as the following formula (2):

$$Δ y ( t ) = ( {C}_{1} - {q}^{′} / {p}^{′} ) \times exp [ - {p}^{′} ( t / Δ t - 1 ) ] + {q}^{′} / {p}^{′} , \qquad ( 2 )$$

where Δy(t) represents the deviation forecast function, i.e., a difference value between the actual test performance value and the forecasted performance value at a moment t; and p′ and q′ are unknown parameters.
S106: the performance degradation forecast function is corrected by using the deviation forecast function.

Specifically, the deviation forecast function and the performance degradation forecast function are superimposed to implement the correction of the performance degradation forecast function.

In the present embodiment, the corrected performance degradation forecast function is shown as the following formula (3):

$${y}^{′} ( t ) = ( {A}_{1} - q / p ) \times exp [ - p ( t / Δ t - 1 ) ] + ( {C}_{1} - {q}^{′} / {p}^{′} ) \times exp [ - {p}^{′} ( t / Δ t - 1 ) ] + q / p + {q}^{′} / {p}^{′} , \qquad ( 3 )$$

Where y′(t) represents the corrected forecast performance value, that is, a product performance parameter correction forecast value at a moment t.
S107: performance degradation failure time of the to-be-tested product is determined based on the corrected performance degradation forecast function and a performance degradation failure threshold value of the to-be-tested product.

Assuming that the performance degradation failure threshold value of the product is Q, the performance degradation failure time t of the to-be-tested product under the first stress condition is obtained by solving the following equation.

In the embodiment, the performance degradation failure time t of the to-be-tested product is calculated from the following formula (4):

$$Q = ( {A}_{1} - q / p ) \times exp [ - p ( t / Δ t - 1 ) ] + ( {C}_{1} - {q}^{′} / {p}^{′} ) \times exp [ - {p}^{′} ( t / Δ t - 1 ) ] + q / p + {q}^{′} / {p}^{′} . \qquad ( 4 )$$

In the above-mentioned accelerated test data analysis method based on the gray forecast model, the performance degradation forecast function and the deviation forecast function of the to-be-tested product are constructed through the gray forecast model, so that the accurate analysis of small sample test data (the actual test performance value and the forecast deviation value) is implemented. In addition, after the forecasted performance value of the to-be-tested product at each test moment is forecasted, the difference value between the actual test performance value and the forecasted performance value of the to-be-tested product at each test moment is further analyzed to determine the deviation forecast function; and the performance degradation forecast function is corrected by using the deviation forecast function, thereby further improving the accuracy of the performance forecast analysis of the to-be-tested product.

In an embodiment, the present disclosure provides an alternative mode to determine the performance degradation forecast function of the to-be-tested product according to the actual test performance value of the to-be-tested product at each test moment based on the grey forecast model, that is, provides a mode to refine the step S102. The implementation process may include the following steps:
an accumulation calculation is performed on an actual test performance value of the to-be-tested product at a test moment and actual test performance values of the to-be-tested product at other test moments before the test moment according to the grey forecast model, to obtain a performance transformation value of the to-be-tested product at the test moment;
a value of an unknown parameter in an initial performance degradation forecast function is determined according to the performance transformation value and the actual test performance value of the to-be-tested product at each test moment, and the performance degradation forecast function of the to-be-tested product is obtained.

Specifically, the actual test performance values are transformed to obtain new sequence data B₁, B₂, . . . , B_{d}, . . . , Bₘ, satisfying:

$$[ \begin{matrix}p \\ q\end{matrix} ] = {( [ \begin{matrix}\frac{- {B}_{1} - {B}_{2}}{2} & \frac{- {B}_{2} - {B}_{3}}{2} & … & \frac{- {B}_{m - 1} - {B}_{m}}{2} \\ 1 & 1 & … & 1\end{matrix} ] \times [ \begin{matrix}- ( {B}_{1} + {B}_{2} ) / 2 & 1 \\ - ( {B}_{2} + {B}_{3} ) / 2 & 1 \\ … & … \\ - ( {B}_{m - 1} + {B}_{m} ) / 2 & 1\end{matrix} ] )}^{- 1} \times [ \begin{matrix}\frac{- {B}_{1} - {B}_{2}}{2} & \frac{- {B}_{2} - {B}_{3}}{2} & … & \frac{- {B}_{m - 1} - {B}_{m}}{2} \\ 1 & 1 & … & 1\end{matrix} ] \times [ \begin{matrix}{A}_{2} \\ {A}_{3} \\ … \\ {A}_{m}\end{matrix} ] .$$

As for the unknown parameters p and q in the formula (1), the calculation process is as follows:

$$[ \begin{matrix}p \\ q\end{matrix} ] = {( [ \begin{matrix}\frac{- {B}_{1} - {B}_{2}}{2} & \frac{- {B}_{2} - {B}_{3}}{2} & … & \frac{- {B}_{m - 1} - {B}_{m}}{2} \\ 1 & 1 & … & 1\end{matrix} ] \times [ \begin{matrix}- ( {B}_{1} + {B}_{2} ) / 2 & 1 \\ - ( {B}_{2} + {B}_{3} ) / 2 & 1 \\ … & … \\ - ( {B}_{m - 1} + {B}_{m} ) / 2 & 1\end{matrix} ] )}^{- 1} \times [ \begin{matrix}\frac{- {B}_{1} - {B}_{2}}{2} & \frac{- {B}_{2} - {B}_{3}}{2} & … & \frac{- {B}_{m - 1} - {B}_{m}}{2} \\ 1 & 1 & … & 1\end{matrix} ] \times [ \begin{matrix}{A}_{2} \\ {A}_{3} \\ … \\ {A}_{m}\end{matrix} ] .$$

In an embodiment, the present disclosure provides an alternative mode to determine the deviation forecast function according to the forecast deviation value of the to-be-tested product at each test moment based on the grey forecast model, i.e., provides a mode to refine the step S105. The implementation process may include the following steps:
an accumulation calculation is performed on a forecast deviation value of the to-be-tested product at a test moment and forecast deviation values of the to-be-tested product at other test moments before the test moment according to the grey forecast model, to obtain a deviation transformation value of the to-be-tested product at the test time;
a value of an unknown parameter in the initial deviation forecast function is determined according to the forecast deviation value and the deviation transformation value of the to-be-tested product at each test moment, and the performance degradation forecast function of the to-be-tested product is obtained.

Specifically, the difference value between the actual test performance value and the forecasted performance value at each test moment is set to be C₁, C₂, C₃, . . . , C_{d}, . . . , Cₘ, satisfying

$${C}_{d} = y ( d Δ t ) - {A}_{d} .$$

Similarly, the forecast deviation values are transformed to obtain new sequence data D₁, D₂, D₃, . . . , D_{d}, . . . , Dₘ, satisfying:

$${D}_{d} = {\sum }_{i = 1}^{d} {C}_{i} .$$

For the formula (2), the parameter values p′ and q′ are obtained by solving the following matrix equations:

$$[ \begin{matrix}{p}^{′} \\ {q}^{′}\end{matrix} ] = {( [ \begin{matrix}\frac{- {D}_{1} - {D}_{2}}{2} & \frac{- {D}_{2} - {D}_{3}}{2} & … & \frac{- {D}_{m - 1} - {D}_{m}}{2} \\ 1 & 1 & … & 1\end{matrix} ] \times [ \begin{matrix}- ( {D}_{1} + {D}_{2} ) / 2 & 1 \\ - ( {D}_{2} + {D}_{3} ) / 2 & 1 \\ … & … \\ - ( {D}_{m - 1} + {D}_{m} ) / 2 & 1\end{matrix} ] )}^{- 1} \times [ \begin{matrix}\frac{- {D}_{1} - {D}_{2}}{2} & \frac{- {D}_{2} - {D}_{3}}{2} & … & \frac{- {D}_{m - 1} - {D}_{m}}{2} \\ 1 & 1 & … & 1\end{matrix} ] \times [ \begin{matrix}{C}_{2} \\ {C}_{3} \\ … \\ {C}_{m}\end{matrix} ] .$$

In the embodiment, the common generation mode of the gray sequence may include an accumulation generation, a cumulative subtraction generation, and a weighted accumulation generation. In the embodiment, the accumulation generation is used.

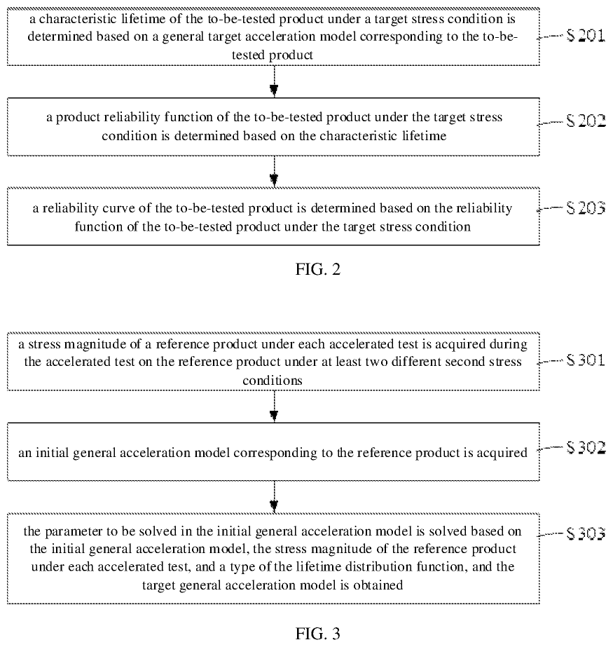

In an embodiment, as shown in FIG. 2, the accelerated test data analysis method based on the grey forecast model in the present embodiment may further include:
S201: a characteristic lifetime of the to-be-tested product under a target stress condition is determined based on a general target acceleration model corresponding to the to-be-tested product.

Specifically, as shown in FIG. 3, the step of obtaining the general target acceleration model corresponding to the to-be-tested product may include:
S301: a stress magnitude of a reference product under each accelerated test is acquired during the accelerated test on the reference product under at least two different second stress conditions.

The reference product is of the same type as the to-be-tested product.

Specifically, in the present embodiment, the accelerated test is performed on each reference product under at least two different second stress conditions. As an example, it is assumed that there are c groups of accelerated tests with different stress levels (the second stress condition), k=1, 2, . . . , c; the number of products at each stress level is n, and the product serial numbers are 1, 2, . . . , i, . . . , n; i=1, 2, . . . , n. According to the above-mentioned steps S101 to S107, the performance degradation failure time t of each reference product under each group of accelerated stresses can be obtained, as shown in the following Table 1:

TABLE 1

| | Product | performance |
|---|---|---|
| Accelerated test | serial number | degradation failure time |
| First group | 1 | t₁₁ |
| | 2 | t₁₂ |
| | . . . | . . . |
| | n | t₁ₙ |
| Second group | 1 | t₂₁ |
| | 2 | t₂₂ |
| | . . . | . . . |
| | n | t₂ₙ |
| . . . | . . . | . . . |
| c-th group | 1 | t_{c1} |
| | 2 | t_{c2} |
| | . . . | . . . |
| | n | T_{cn} |

Optionally, assuming that each group of accelerated tests have f kinds of stresses, and the stress magnitudes of the k-th group of accelerated tests are respectively Gₖ₁, Gₖ₂, . . . , Gₖⱼ, . . . , G_{kf}, and j=1, 2, . . . , f
S302: an initial general acceleration model corresponding to the reference product is acquired.

The initial general acceleration model includes a parameter to be solved. Specifically, the general acceleration model of the product is shown as the following formula (5):

$${η}_{i} = exp [ {M}_{0} + {\sum }_{j = 1}^{f} ( {H}_{j} \times σ ( {G}_{kj} ) ) + {\sum }_{j = 1}^{f} {\sum }_{u = j + 1}^{f} ( {I}_{ju} \times σ ( {G}_{kj} ) \times σ ( {G}_{ku} ) ) ] , \qquad ( 5 )$$

where ηₖ denotes the characteristic lifetime of the product in the k-th group of accelerated tests, σ(Gₖⱼ) represents a function related to the accelerated stress Gₖⱼ; M₀, H₁, H₂, . . . , Hⱼ, . . . , H_{f} are all unknown parameters; I₁₂, I₁₃, . . . , I_{1f}, I₂₃, I₂₄, . . . , I₂, . . . , I_{f-1}, I_{f} are unknown parameters among non-independent stresses (i.e., parameters to be solved in the initial general acceleration model). If the stresses Gₖⱼ and Gₖᵤ are independent of each other, then Iⱼᵤ=0.

In particular, the acceleration model under a single stress, a plurality of independent stresses, a plurality of non-independent stresses is shown in the following Table 2:

TABLE 2

| Accelerated | | |
|---|---|---|
| stress | | |
| condition | Accelerated stress example | Accelerated model example |
| Single stress | Temperature T [symbol] | $η \text{?} = exp ( M \text{?} + H \text{?} \times \frac{1}{T \text{?}} )$ |
| | Humidity RH [symbol] | [symbol] = exp(M₀ + H₁ × ln(RH [symbol] )) |
| | Voltage E [symbol] | [symbol] = exp(M₀ + H₁ × ln(E [symbol] )) |
| | ... | ... |
| | Vibration V [symbol] | [symbol] = exp(M₀ + H₁ × ln(V [symbol] )) |
| a plurality | Temperature Tₖₗ and Humidity RHₖ₁ | $η \text{?} = exp ( M \text{?} + H \text{?} \times \frac{1}{T \text{?}} + H \text{?} \times ln ( RH \text{?} ) )$ |
| of independent | Temperature Tₖ₁ and Vibration Vₖ₁ | $η \text{?} = exp ( M \text{?} + H \text{?} \times \frac{1}{T \text{?}} + H \text{?} \times ln ( V \text{?} ) )$ |
| stresses | ... | ... |
| | Temperature Tₖ₁, Humidity RHₖ₁, Vibration Vₖ₁ | $η \text{?} = exp ( M \text{?} + H \text{?} \frac{1}{T \text{?}} + H \text{?} ln ( RH \text{?} ) + H \text{?} ln ( V \text{?} ) )$ |
| a plurality | Temperature Tₖ₁ and Humidity RHₖ₁ | $η \text{?} = exp ( M \text{?} + H \text{?} \frac{1}{T \text{?}} + H \text{?} ln ( RH \text{?} ) + \text{?} \frac{ln ( RH \text{?} )}{T \text{?}} )$ |
| of non- independent | Temperature Tₖ₁ and Vibration Vₖ₁ | $η \text{?} = exp ( M \text{?} + H \text{?} \frac{1}{T \text{?}} + H \text{?} ln ( V \text{?} ) + \text{?} \frac{ln ( V \text{?} )}{T \text{?}} )$ |
| stresses | ... | ... |
| | Temperature Tₖ₁, Humidity RHₖ₁, Vibration Vₖ₁ | $η \text{?} = exp ( \begin{matrix}M \text{?} + H \text{?} \frac{1}{T \text{?}} + H \text{?} ln ( RH \text{?} ) + \text{?} ln ( V \text{?} ) + \\ \text{?} \frac{ln ( RH \text{?} )}{T \text{?}} + \text{?} \frac{ln ( V \text{?} )}{T \text{?}} + \text{?} ln ( RH \text{?} ) ln ( V \text{?} )\end{matrix} )$ |

[symbol]

indicates data missing or illegible when filed

In the present embodiment, the step of selecting the initial general acceleration model may include: the initial general acceleration model is determined from candidate general acceleration models according to a stress type of each second stress condition.

Specifically, the initial general acceleration model can be selected according to the examples in the Table 2.
S303: the parameter to be solved in the initial general acceleration model is solved based on the initial general acceleration model, the stress magnitude of the reference product under each accelerated test, and a type of the lifetime distribution function, and the target general acceleration model is obtained.

The type of the lifetime distribution function refers to a function distribution for forecasting the lifetime, for example, an exponential distribution function, a Weibull distribution function, a normal distribution function, and a lognormal distribution function.

Specifically, during the solving of the parameter to be solved in the initial general acceleration model, as an example: (1) when the lifetime distribution function is an exponential distribution function:
when the lifetime distribution function of the to-be-tested product is an exponential distribution function, a product probability density function under the accelerated stress is represented as:

$${f}_{k} ( t ) = \frac{1}{{η}_{k}} exp ( - \frac{t}{{η}_{k}} ) ,$$

where t denotes time.

A likelihood function L of the to-be-tested product is represented as:

$$\{ \begin{matrix}L ( {M}_{0} , {H}_{1} , … , {H}_{f} , {I}_{12} , … , {I}_{f - 1 f} ) = {{\prod }_{k = 1}}^{c} {{\prod }_{i = 1}}^{n} \frac{1}{{η}_{k}} exp ( - \frac{{t}_{ki}}{{η}_{k}} ) \\ {η}_{i} = exp [ {M}_{0} + {\sum }_{j = 1}^{f} ( {H}_{j} \times σ ( {G}_{kj} ) ) + {\sum }_{j = 1}^{f} {\sum }_{u = j + 1}^{f} ( {I}_{ju} \times σ ( {G}_{kj} ) \times σ ( {G}_{ku} ) ) ]\end{matrix} ,$$

where the values of the parameters M₀, H₁, H₂, . . . , Hⱼ, . . . , H_{f}, I₁₂, I₁₃, . . . , I_{1f}, I₂₃, I₂₄, . . . , I_{2f}, . . . , I_{f-1}, I_{f} can be obtained by solving the following equations:

$$\{ \begin{matrix}\frac{d L ( {M}_{0} , {H}_{1} , … , {H}_{f} , {I}_{12} , … , {I}_{f - 1 f} )}{{dM}_{0}} = 0 \\ \frac{d L ( {M}_{0} , {H}_{1} , … , {H}_{f} , {I}_{12} , … , {I}_{f - 1 f} )}{{dH}_{1}} = 0 \\ \frac{d L ( {M}_{0} , {H}_{1} , … , {H}_{f} , {I}_{12} , … , {I}_{f - 1 f} )}{{dH}_{f}} = 0 \\ \frac{d L ( {M}_{0} , {H}_{1} , … , {H}_{f} , {I}_{12} , … , {I}_{f - 1 f} )}{{dI}_{12}} = 0 \\ … \\ \frac{d L ( {M}_{0} , {H}_{1} , … , {H}_{f} , {I}_{12} , … , {I}_{f - 1 f} )}{{dI}_{f - 1 f}} = 0\end{matrix} .$$

Accordingly, the characteristic lifetime η₀ of the to-be-tested product under the target stress condition (with normally used stress magnitude) is determined as:

$${η}_{0} = exp [ {M}_{0} + {\sum }_{j = 1}^{f} ( {H}_{j} \times σ ( {G}_{j}^{′} ) ) + {\sum }_{j = 1}^{f} {\sum }_{u = j + 1}^{f} ( {I}_{ju} \times σ ( {G}_{j}^{′} ) \times σ ( {G}_{u}^{′} ) ) ] ,$$

where G′₁, G′₂, . . . , G′ⱼ, . . . , G′_{f} are the normally used stress magnitudes.
(2) when the lifetime distribution function is a Weibull distribution function:

if the lifetime distribution function of the to-be-tested product is a Weibull distribution function, the product probability density function fₖ (t) under the accelerated stress is represented as:

$${f}_{k} ( t ) = \frac{α}{{η}_{k}} {( \frac{t}{{η}_{k}} )}^{α - 1} {e}^{- {( \frac{t}{{η}_{k}} )}^{α}} ,$$

where α is a scale parameter of the Weibull distribution function.

The likelihood function L of the to-be-tested product is represented as:

$$\{ \begin{matrix}L ( α , {M}_{0} , {H}_{1} , … , {H}_{f} , {I}_{12} , … , {I}_{f - 1 , f} ) = {\prod }_{c = 1}^{c} {\prod }_{j = 1}^{n} \frac{α}{{η}_{k}} {( \frac{{t}_{H}}{{η}_{k}} )}^{α - 1} {e}^{- {( \frac{{t}_{n}}{{η}_{k}} )}^{α}} \\ {η}_{k} = exp [ {M}_{0} + {\sum }_{j = 1}^{f} ( {H}_{j} \times σ ( {G}_{kj} ) ) + {\sum }_{j = 1}^{f} {\sum }_{u = j + 1}^{f} ( {I}_{ju} \times σ ( {G}_{kj} ) \times σ ( {G}_{ku} ) ) ]\end{matrix} ,$$

The values of the parameters α, M₀, H₁, H₂, . . . , Hⱼ, . . . , H_{f}, I₁₂, I₁₃, . . . , I_{1f}, I₂₃, I₂₄, . . . , I_{2f}, . . . , I_{f-1}, I_{f} are obtained by solving the following equations:

$$\{ \begin{matrix}\frac{dL ( {M}_{0} , {H}_{1} , … , {H}_{f} , {I}_{12} , … , {I}_{f - 1 f} )}{d α} = 0 \\ \frac{dL ( {M}_{0} , {H}_{1} , … , {H}_{f} , {I}_{12} , … , {I}_{f - 1 f} )}{{dM}_{0}} = 0 \\ \frac{dL ( {M}_{0} , {H}_{1} , … , {H}_{f} , {I}_{12} , … , {I}_{f - 1 f} )}{{dH}_{1}} = 0 \\ \frac{dL ( {M}_{0} , {H}_{1} , … , {H}_{f} , {I}_{12} , … , {I}_{f - 1 f} )}{{dH}_{f}} = 0 \\ \frac{dL ( {M}_{0} , {H}_{1} , … , {H}_{f} , {I}_{12} , … , {I}_{f - 1 f} )}{{dI}_{12}} = 0 \\ … \\ \frac{dL ( {M}_{0} , {H}_{1} , … , {H}_{f} , {I}_{12} , … , {I}_{f - 1 f} )}{{dI}_{f - 1 f}} = 0\end{matrix} .$$

Accordingly, the characteristic lifetime η₀ of the to-be-tested product under the target stress condition (with the normally used stress magnitude) is determined as:

$${η}_{0} = exp [ {M}_{0} + {\sum }_{j = 1}^{f} ( {H}_{j} \times σ ( {G}_{j}^{′} ) ) + {\sum }_{j = 1}^{f} {\sum }_{u = j + 1}^{f} ( {I}_{ju} \times σ ( {G}_{j}^{′} ) \times σ ( {G}_{u}^{′} ) ) ] ,$$

where G′₁, G′₂, . . . , G′ⱼ, . . . , G′_{f} are normally used stress magnitudes.
(3) when the lifetime distribution function is a normal distribution function:
if the lifetime distribution function of the to-be-tested product is a normal distribution function, the probability density function fₖ (t) of the to-be-tested product under the accelerated stress is represented as:

$${f}_{k} ( t ) = \frac{1}{\sqrt{2 π} σ} {e}^{- \frac{1}{2} {( \frac{t - {η}_{k}}{σ} )}^{2}} ,$$

where σ is a standard deviation of the normal distribution function.

The likelihood function L of the to-be-tested product is represented as:

$$\{ \begin{matrix}L ( α , {M}_{0} , {H}_{1} , … , {H}_{f} , {I}_{12} , … , {I}_{f - 1 f} ) = {\prod }_{k = 1}^{c} {\prod }_{i = 1}^{n} \frac{1}{\sqrt{2 π} σ} {e}^{- \frac{1}{2} {( \frac{{t}_{kj} - {η}_{k}}{σ} )}^{2}} \\ {η}_{k} = exp [ {M}_{0} + {\sum }_{j = 1}^{j} ( {H}_{j} \times σ ( {G}_{kj} ) ) + {\sum }_{j = 1}^{f} {\sum }_{u = j + 1}^{f} ( {I}_{ju} \times σ ( {G}_{kj} ) \times σ ( {G}_{ku} ) ) ]\end{matrix} ,$$

The values of the parameters σ, M₀, H₁, H₂, . . . , Hⱼ, . . . , H_{f}, I₁₂, I₁₃, . . . , I_{1f}, I₂₃, I₂₄, . . . , I_{2f}, . . . , I_{f-1}, I_{f} are obtained by solving the following equations:

$$\{ \begin{matrix}\frac{dL ( {M}_{0} , {H}_{1} , … , {H}_{f} , {I}_{12} , … , {I}_{f - 1 f} )}{d σ} = 0 \\ \frac{dL ( {M}_{0} , {H}_{1} , … , {H}_{f} , {I}_{12} , … , {I}_{f - 1 f} )}{{dM}_{0}} = 0 \\ \frac{dL ( {M}_{0} , {H}_{1} , … , {H}_{f} , {I}_{12} , … , {I}_{f - 1 f} )}{{dH}_{1}} = 0 \\ \frac{dL ( {M}_{0} , {H}_{1} , … , {H}_{f} , {I}_{12} , … , {I}_{f - 1 f} )}{{dH}_{f}} = 0. \\ \frac{dL ( {M}_{0} , {H}_{1} , … , {H}_{f} , {I}_{12} , … , {I}_{f - 1 f} )}{{dI}_{12}} = 0 \\ … \\ \frac{dL ( {M}_{0} , {H}_{1} , … , {H}_{f} , {I}_{12} , … , {I}_{f - 1 f} )}{{dI}_{f - 1 f}} = 0\end{matrix}$$

Accordingly, the characteristic lifetime η₀ of the to-be-tested product under the target stress condition (with the normally used stress magnitude) is determined as:

$${η}_{0} = exp [ {M}_{0} + {\sum }_{j = 1}^{f} ( {H}_{j} \times σ ( {G}_{j}^{′} ) ) + {\sum }_{j = 1}^{f} {\sum }_{u = j + 1}^{f} ( {I}_{ju} \times σ ( {G}_{j}^{′} ) \times σ ( {G}_{u}^{′} ) ) ] ,$$

where G′₁, G′₂, . . . , G′ⱼ, . . . , G′_{f} are normally used stress magnitudes.
(4) when the lifetime distribution function is a lognormal distribution function:
if the lifetime distribution function of the to-be-tested product is a lognormal distribution function, then the product probability density function fₖ (t) under the accelerated stress is represented as:

$${f}_{k} ( t ) = \frac{1}{\sqrt{2 π} σ t} {e}^{- \frac{1}{2} {( \frac{lnt - {η}_{k}}{σ} )}^{2}} ,$$

where σ is the standard deviation of the normal distribution function.

The likelihood function L of the to-be-tested product is represented as:

$$\{ \begin{matrix}L ( α , {M}_{0} , {H}_{1} , … , {H}_{f} , {I}_{12} , … , {I}_{f - 1 j} ) = {\prod }_{k = 1}^{c} {\prod }_{i = 1}^{n} \frac{1}{\sqrt{2 π} σ {t}_{kj}} {e}^{- \frac{1}{2} {( \frac{{lnt}_{kj} - {η}_{k}}{σ} )}^{2}} \\ {η}_{k} = exp [ {M}_{0} + {\sum }_{j = 1}^{f} ( {H}_{j} \times σ ( {G}_{kj} ) ) + {\sum }_{j = 1}^{f} {\sum }_{u = j + 1}^{f} ( {I}_{ju} \times σ ( {G}_{kj} ) \times σ ( {G}_{ku} ) ) ]\end{matrix} ,$$

the values of the parameters σ, M₀, H₁, H₂, . . . , Hⱼ, . . . , H_{f}, I₁₂, I₁₃, . . . , I_{1f}, I₂₃, I₂₄, . . . , I_{2f}, . . . , I_{f-1}, I_{f} are obtained by solving the following equations:

$$\{ \begin{matrix}\frac{dL ( {M}_{0} , {H}_{1} , … , {H}_{f} , {I}_{12} , … , {I}_{f - 1 f} )}{d σ} = 0 \\ \frac{dL ( {M}_{0} , {H}_{1} , … , {H}_{f} , {I}_{12} , … , {I}_{f - 1 f} )}{{dM}_{0}} = 0 \\ \frac{dL ( {M}_{0} , {H}_{1} , … , {H}_{f} , {I}_{12} , … , {I}_{f - 1 f} )}{{dH}_{1}} = 0 \\ \frac{dL ( {M}_{0} , {H}_{1} , … , {H}_{f} , {I}_{12} , … , {I}_{f - 1 f} )}{{dH}_{f}} = 0 \\ \frac{dL ( {M}_{0} , {H}_{1} , … , {H}_{f} , {I}_{12} , … , {I}_{f - 1 f} )}{{dI}_{12}} = 0 \\ … \\ \frac{dL ( {M}_{0} , {H}_{1} , … , {H}_{f} , {I}_{12} , … , {I}_{f - 1 f} )}{{dI}_{f - 1 f}} = 0\end{matrix} .$$

Accordingly, the characteristic lifetime η₀ of the to-be-tested product under the target stress condition (with the normally used stress magnitude) is determined as:

$${η}_{0} = exp [ {M}_{0} + {\sum }_{j = 1}^{f} ( {H}_{j} \times σ ( {G}_{j}^{′} ) ) + {\sum }_{j = 1}^{f} {\sum }_{u = j + 1}^{f} ( {I}_{ju} \times σ ( {G}_{j}^{′} ) \times σ ( {G}_{u}^{′} ) ) ] ,$$

where G′₁, G′₂, . . . , G′ⱼ, . . . , G′_{f} are normally used stress magnitude.
S202: a product reliability function of the to-be-tested product under the target stress condition is determined based on the characteristic lifetime.

Specifically,
(1) when the lifetime distribution function is an exponential distribution function:
the probability density function f (t) of the to-be-tested product under the normally used stress is represented as:

$$f ( t ) = \frac{1}{{η}_{0}} exp ( - \frac{t}{{η}_{0}} ) ;$$

an unreliability function F(t) of the to-be-tested product under the normally used stress is represented as:

$$F ( t ) = 1 - exp ( - \frac{t}{{η}_{0}} ) ;$$

the reliability function R(t) of the to-be-tested product under the normally used stress is represented as:

$$R ( t ) = exp ( - \frac{t}{{η}_{0}} ) .$$

(2) When the lifetime distribution function is a Weibull distribution function:
the probability density function f (t) of the to-be-tested product under the normally used stress is represented as:

$$f ( t ) = \frac{α}{{η}_{0}} {( \frac{t}{{η}_{0}} )}^{α - 1} {e}^{- ( \frac{t}{{η}_{0}} )} \text{?} ;$$

$$\text{?} \text{indicates text missing or illegible when filed}$$

the unreliability function F(t) of the to-be-tested product under the normally used stress is represented as:

$$F ( t ) = 1 - exp [ - {( \frac{t}{{η}_{0}} )}^{a} ] ;$$

the reliability function R(t) of the to-be-tested product under the normally used stress is represented as:

$$R ( t ) = exp [ - {( \frac{t}{{η}_{0}} )}^{a} ] .$$

(3) When the lifetime distribution function is a normal distribution function:
the probability density function f(t) of the to-be-tested product under the normally used stress is represented as:

$$f ( t ) = \frac{1}{\sqrt{2 π} σ} {e}^{- \frac{1}{2} {( \frac{t - {η}_{0}}{σ} )}^{2}} ;$$

the unreliability function F(t) of the to-be-tested product under the normally used stress is represented as:

$$F ( t ) = {\int }_{0}^{t} \frac{1}{\sqrt{2 π} σ} {e}^{- \frac{1}{2} {( \frac{x - {η}_{0}}{σ} )}^{2}} dx ;$$

the reliability function R(t) of the to-be-tested product under the normally used stress is represented as:

$$R ( t ) = 1 - {\int }_{0}^{t} \frac{1}{\sqrt{2 π} σ} {e}^{- \frac{1}{2} {( \frac{x - {η}_{0}}{σ} )}^{2}} dx .$$

(4) When the lifetime distribution function is a lognormal distribution function:
the probability density function f(t) of the to-be-tested product under the normally used stress is represented as:

$$f ( t ) = \frac{1}{\sqrt{2 π} σ t} {e}^{- \frac{1}{2} {( \frac{ln t - {η}_{0}}{σ} )}^{2}} ;$$

the unreliability function F(t) of the to-be-tested product under the normally used stress is represented as:

$$F ( t ) = {\int }_{0}^{t} \frac{1}{\sqrt{2 π} σ x} {e}^{- \frac{1}{2} {( \frac{ln x - {η}_{0}}{σ} )}^{2}} dx ;$$

the reliability function R(t) of the to-be-tested product under the normally used stress is represented as:

$$R ( t ) = 1 - {\int }_{0}^{t} \frac{1}{\sqrt{2 π} σ x} {e}^{- \frac{1}{2} {( \frac{ln x - {η}_{0}}{σ} )}^{2}} dx .$$

Further, the accelerated test data analysis method based on the grey forecast model may further include: an average lifetime of the to-be-tested product is determined based on the characteristic lifetime and the type of the lifetime distribution function.

Specifically, the average lifetime of the product is evaluated according to the type of the lifetime distribution function of the product, as shown in the following Table 3, where Γ(x) is a gamma function.

TABLE 3

| Serial | Type of lifetime | | |
|---|---|---|---|
| number | distribution function | Reliability function | Average lifetime |
| 1 | Exponential distribution function | $R ( t ) = exp ( - \frac{t}{{η}_{0}} )$ | η₀ |
| 2 | Weibull distribution function | $R ( t ) = exp [ - {( \frac{t}{η \text{?}} )}^{a} ]$ | η₀ × Γ(1 + 1/a) |
| 3 | Normal distribution function | $R ( t ) = 1 - {\int }_{0}^{\text{?}} \frac{1}{\sqrt{2 π} σ} {e}^{- \frac{1}{2} {( \text{?} )}^{2}} dx$ | η₀ |
| 4 | Lognormal distribution function | $R ( t ) = 1 - {\int }_{0}^{\text{?}} \frac{1}{\sqrt{2 π} σ x} {e}^{- \frac{1}{2} {( \frac{ln x \text{?}}{\text{?}} )}^{2}} dx$ | exp(η₀ + σ²/2) |

$\text{?} \text{indicates text missing or illegible when filed}$

S203: a reliability curve of the to-be-tested product is determined based on the reliability function of the to-be-tested product under the target stress condition.

As an example, an accelerated test is performed on a certain type of product according to the above-described accelerated test data analysis method based on the grey forecast model, and a process of evaluating a product lifetime index is as follows.

### I) Product Grey Forecast Model Analysis

Under the tress of the accelerated test, a performance test is performed on the product at equal intervals for a total of 10 tests, and the performance degradation of which is shown in the following Table 4:

TABLE 4

| Serial number | 1 | 2 | 3 | 4 | 5 | . . . | 9 | 10 |
|---|---|---|---|---|---|---|---|---|
| Time (hour) | 240 | 480 | 720 | 960 | 1200 | . . . | 2160 | 2400 |
| Initial performance | 12.805 | 12.814 | 12.833 | 12.861 | 12.892 | . . . | 13.029 | 13.159 |
| value (volt) | | | | | | | | |

A performance degradation forecast function is obtained by solving as:

$$y ( t ) = 4303.91 \times exp [ - 2.96 \times 1 {0}^{- 3} ( t / Δ t - 1 ) ] + 4291 \text{.11} .$$

The product performance parameter forecast values are shown in Table 5 below:

TABLE 5

| Serial number | 1 | 2 | 3 | 4 | 5 | 9 | 10 |
|---|---|---|---|---|---|---|---|
| Time (hour) | 240 | 480 | 720 | 960 | 1200 | 2160 | 2400 |
| Predicted performance | 12.805 | 12.782 | 12.820 | 12.858 | 12.896 | 13.050 | 13.089 |
| values (volt) | | | | | | | |

A deviation value between the product performance parameter forecast value and the initial performance parameter value is shown in the following Table 6:

TABLE 6

| Serial number | 1 | 2 | 3 | 4 | 5 | . . . | 9 | 10 |
|---|---|---|---|---|---|---|---|---|
| Time (hour) | 240 | 480 | 720 | 960 | 1200 | . . . | 2160 | 2400 |
| Deviation value | 0 | 0.032 | 0.013 | 0.003 | −0.004 | . . . | −0.021 | 0.07 |
| (volt) | | | | | | | | |

The deviation values are transformed positively and analyzed, and a deviation forecast function is obtained as follows:

$$Δ y ( t ) = - 31.46 \times exp [ - 1.92 \times {10}^{- 3} ( t / Δ t - 1 ) ] + 31.46 .$$

Under the tress of the accelerated test, the performance degradation correction forecast function is as follows:

$${y}^{′} ( t ) = 4303.91 \times exp [ - 2.96 \times {10}^{- 3} ( t / Δ t - 1 ) ] - 31.46 \times exp [ - 1.92 \times {10}^{- 3} ( t / Δ t - 1 ) ] + 4322.57 .$$

In combination with the product performance degradation failure threshold value, the performance degradation failure time of the product is obtained as 4072 hours under the stress of the accelerated test.

In the same manner, the performance degradation failure time of each product under each group of accelerated stresses can be obtained.

### II) Product Acceleration Model Analysis

There are five groups of accelerated tests with different stress levels performed on the product, each stress level corresponds to the temperature stress and the humidity stress. Considering that the effects of the temperature and humidity on the product are not independent, the acceleration model of the product is as follows:

$${η}_{k} = exp ( {M}_{0} + {H}_{1} \frac{1}{T} \text{?} + {H}_{2} ln ( RH \text{?} ) + I \text{?} \frac{ln ( RH \text{?} )}{T \text{?}} ) .$$

$$\text{?} \text{indicates text missing or illegible when filed}$$

The product lifetime distribution function is the Weibull distribution function. By solving the acceleration model of the product, the product reliability function R(t) at normally used stress (temperature 25° C. and humidity 65%) is obtained as:

$$R ( t ) = exp [ - ( \frac{t}{2.98 \times 10 \text{?}} ) \text{?} ] .$$

$$\text{?} \text{indicates text missing or illegible when filed}$$

### III) Product Lifetime Index Evaluation

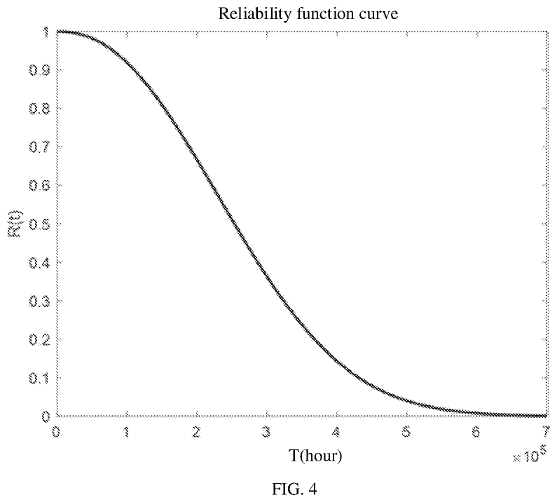

According to the product reliability function, a reliability function curve as shown FIG. 4 is obtained.

Thus, the average lifetime of the product under the normally used stress is 2.64×10⁵ h.

The average lifetime value of the product in actual use is close to the result of the test evaluation, which indicates that the evaluation accuracy of the solution is higher.

It should be appreciated that although the steps in the flow charts mentioned in the above embodiments are shown sequentially as indicated by arrows, these steps are not definitely performed sequentially as indicated by the arrows. Unless expressly stated herein, these steps are not performed in a strict order but may be performed in other orders. Moreover, at least part of the steps in the flow charts mentioned in the above embodiments may include a plurality of steps or phases, which are not definitely performed at the same moment, but may be performed at different moments, and those steps or phases are not definitely performed in sequence, but may be performed in turns or alternately with other steps or at least part of the steps or phases in other steps.

Based on the same inventive concept, the present disclosure in an embodiment further provides an accelerated test data analysis apparatus based on a gray forecast model, which is configured to implement the above-mentioned accelerated test data analysis method based on the gray forecast model. The solution provided by the apparatus is similar to the solution described in the above method. Therefore, for specific limitations in one or more embodiments of the accelerated test data analysis apparatus based on the grey forecast model, reference can be made to the above limitations on the accelerated test data analysis method based on the grey forecast model, and details are not described herein.

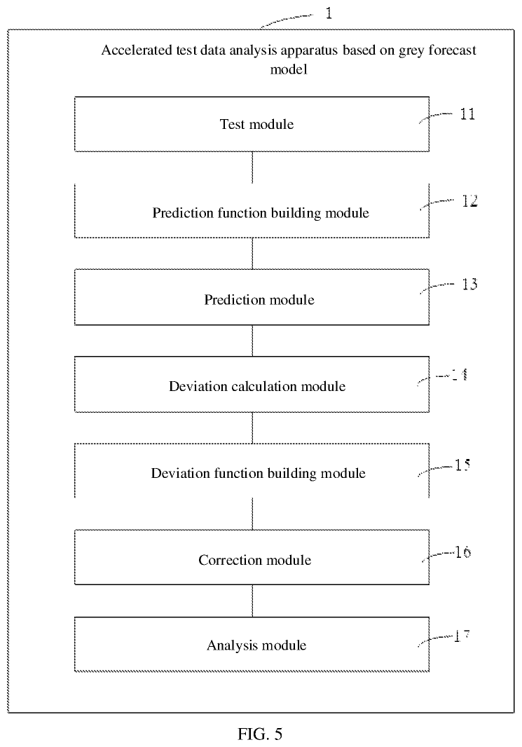

In an embodiment, as shown in FIG. 5, an accelerated test data analysis apparatus 1 based on a grey forecast model is provided, which includes a test module 11, a forecast function building module 12, a forecast module 13, a deviation calculation module 14, a deviation function building module 15, a correction module 16, and an analysis module 17.

The test module 11 is configured to acquire an actual test performance value of a to-be-tested product at each test moment during the accelerated test of the to-be-tested product under a first stress condition.

The forecast function building module 12 is configured to determine a performance degradation forecast function of the to-be-tested product according to the actual test performance value of the to-be-tested product at each test moment based on the gray forecast model.

The forecast module 13 is configured to predict a forecasted performance value of the to-be-tested product at each test moment based on the performance degradation forecast function.

The deviation calculation module 14 is configured to determine a forecast deviation value of the to-be-tested product at each test moment according to a difference value between the actual test performance value and the forecasted performance value of the to-be-tested product at each test moment.

The deviation function building module 15 is configured to determine a deviation forecast function according to the forecast deviation value of the to-be-tested product at each test moment based on the grey forecast model.

The correction module 16 is configured to correct the performance degradation forecast function by using the deviation forecast function.

The analysis module 17 is configured to determine performance degradation failure time of the to-be-tested product based on the corrected performance degradation forecast function and a performance degradation failure threshold value of the to-be-tested product.

In an embodiment, the forecast function building module 12 is further configured to: perform an accumulation calculation on an actual test performance value of the to-be-tested product at a test moment and actual test performance values of the to-be-tested product at other test moments before the test moment according to the grey forecast model, to obtain a performance transformation value of the to-be-tested product at the test moment; and determine a value of an unknown parameter in an initial performance degradation forecast function according to the performance transformation value and the actual test performance value of the to-be-tested product at each test moment, and obtain the performance degradation forecast function of the to-be-tested product.

In an embodiment, the deviation function building module 15 is further configured to: perform an accumulation calculation on a forecast deviation value of the to-be-tested product at a test moment and forecast deviation values of the to-be-tested product at other test moments before the test moment according to the grey forecast model, to obtain a deviation transformation value of the to-be-tested product at the test time; and determine a value of an unknown parameter in the initial deviation forecast function according to the forecast deviation value and the deviation transformation value of the to-be-tested product at each test moment, and obtain the performance degradation forecast function of the to-be-tested product.

In an embodiment, the accelerated test data analysis apparatus based on the gray forecast model may further include a lifetime forecast module 13. The lifetime forecast module 13 may include:
a model selection submodule, configured to determine a characteristic lifetime of the to-be-tested product under a target stress condition based on a general target acceleration model corresponding to the to-be-tested product;
a characteristic forecast submodule, configured to determine a reliability function of the to-be-tested product under the target stress condition based on the characteristic lifetime;
a reliability forecast submodule, configured to determine a reliability curve of the to-be-tested product based on the reliability function of the to-be-tested product under the target stress condition.

In an embodiment, the accelerated test data analysis apparatus based on the grey forecast model may further include a model building module which is further configured to: acquire a stress magnitude of a reference product under each accelerated test during the accelerated test on the reference product under at least two different second stress conditions, in which the reference product is of the same type as the to-be-tested product; acquire an initial general acceleration model corresponding to the reference product, in which the initial general acceleration model includes a parameter to be solved; and solve the parameter to be solved in the initial general acceleration model based on the initial general acceleration model, the stress magnitude of the reference product under each accelerated test, and a type of the lifetime distribution function, and obtain the target general acceleration model.

In an embodiment, the model selection submodule is further configured to determine the initial general acceleration model from candidate general acceleration models according to a stress type of each second stress condition.

In an embodiment, the lifetime forecast module 13 is further configured to determine an average lifetime of the to-be-tested product based on the characteristic lifetime and the type of the lifetime distribution function.

Each module in the above-described accelerated test data analysis apparatus based on the grey forecast model may be implemented in whole or in part by software, hardware, and combinations thereof. The modules may be embedded in or independent of a processor of a computer device in the form of hardware, or may be stored in a memory of a computer device in the form of software to facilitate the processor to invoke and perform operations corresponding to the modules.

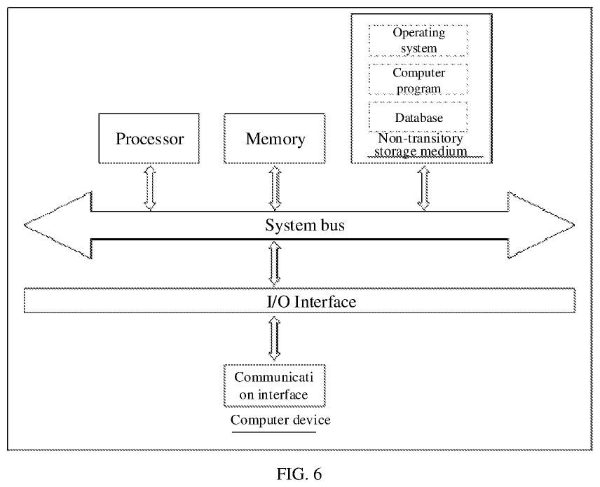

In an embodiment, a computer device is provided, which may be a server, the internal structure of which may be shown in FIG. 6. The computer device may include a processor, a memory, and a network interface connected to each other by a system bus. The processor of the computer device is configured to provide computing and control capabilities. The memory of the computer device may include a non-transitory storage medium and an internal memory. The non-transitory storage medium stores an operating system, a computer program, and a database. The internal memory provides an environment for the operations of the operating system and the computer program in the non-transitory storage medium. The database of the computer device is configured to store the accelerated test data. The network interface of the computer device is configured to communicate with an external terminal through a network connection. The computer program is executed by the processor to implement an accelerated test data analysis method.

It will be appreciated by those skilled in the art that the structure shown in FIG. 6 is a block diagram of only part of the structure associated with the solution of the present disclosure, and does not constitute a limitation on the computer device to which the solution of the present disclosure is applied; and a particular computer device may include more or less components than those shown in the figures, or may combine certain components, or have a different component arrangement.

In an embodiment, a computer device is provided, which may include a processor and a memory storing a computer program, the processor, when executing the computer program, performs the following steps of:
acquiring an actual test performance value of a to-be-tested product at each test moment during the accelerated test of the to-be-tested product under a first stress condition;
determining a performance degradation forecast function of the to-be-tested product according to the actual test performance value of the to-be-tested product at each test moment based on the gray forecast model;
forecasting a forecasted performance value of the to-be-tested product at each test moment based on the performance degradation forecast function;
determining a forecast deviation value of the to-be-tested product at each test moment according to a difference value between the actual test performance value and the forecasted performance value of the to-be-tested product at each test moment;
determining a deviation forecast function according to the forecast deviation value of the to-be-tested product at each test moment based on the grey forecast model;
correcting the performance degradation forecast function by using the deviation forecast function; and
determining performance degradation failure time of the to-be-tested product based on the corrected performance degradation forecast function and a performance degradation failure threshold value of the to-be-tested product.

In an embodiment, as for the step of determining the performance degradation forecast function of the to-be-tested product according to the actual test performance value of the to-be-tested product at each test moment based on the gray forecast model, the processor is further configured to be capable of executing the computer program to: perform an accumulation calculation on an actual test performance value of the to-be-tested product at a test moment and actual test performance values of the to-be-tested product at other test moments before the test moment according to the grey forecast model, to obtain a performance transformation value of the to-be-tested product at the test moment; and determine a value of an unknown parameter in an initial performance degradation forecast function according to the performance transformation value and the actual test performance value of the to-be-tested product at each test moment, and obtain the performance degradation forecast function of the to-be-tested product.

In an embodiment, as for the step of determining the deviation forecast function according to the forecast deviation value of the to-be-tested product at each test moment based on the grey forecast model, the processor is further configured to be capable of executing the computer program to: perform an accumulation calculation on a forecast deviation value of the to-be-tested product at a test moment and forecast deviation values of the to-be-tested product at other test moments before the test moment according to the grey forecast model, to obtain a deviation transformation value of the to-be-tested product at the test time; and determine a value of an unknown parameter in the initial deviation forecast function according to the forecast deviation value and the deviation transformation value of the to-be-tested product at each test moment, and obtain the performance degradation forecast function of the to-be-tested product.

In an embodiment, the processor is further configured to be capable of executing the computer program to: determine a characteristic lifetime of the to-be-tested product under a target stress condition based on a general target acceleration model corresponding to the to-be-tested product; determine a reliability function of the to-be-tested product under the target stress condition based on the characteristic lifetime; and determine a reliability curve of the to-be-tested product based on the reliability function of the to-be-tested product under the target stress condition.

In an embodiment, the processor is further configured to be capable of executing the computer program to: acquire a stress magnitude of a reference product under each accelerated test during the accelerated test on the reference product under at least two different second stress conditions, in which the reference product is of the same type as the to-be-tested product; acquire an initial general acceleration model corresponding to the reference product, in which the initial general acceleration model includes a parameter to be solved; and solve the parameter to be solved in the initial general acceleration model based on the initial general acceleration model, the stress magnitude of the reference product under each accelerated test, and a type of the lifetime distribution function, and obtain the target general acceleration model.

In an embodiment, as for the step of acquiring the initial general acceleration model corresponding to the reference product, the processor is further configured to be capable of executing the computer program to: determine the initial general acceleration model from candidate general acceleration models according to a stress type of each second stress condition.

In an embodiment, the processor is further configured to be capable of executing the computer program to determine an average lifetime of the to-be-tested product based on the characteristic lifetime and the type of the lifetime distribution function.

In an embodiment, a computer-readable storage medium is provided, on which a computer program is provided, the computer program, when executed by a processor, causes the processor to perform the following steps of:
acquiring an actual test performance value of a to-be-tested product at each test moment during the accelerated test of the to-be-tested product under a first stress condition;
determining a performance degradation forecast function of the to-be-tested product according to the actual test performance value of the to-be-tested product at each test moment based on the gray forecast model;
forecasting a forecasted performance value of the to-be-tested product at each test moment based on the performance degradation forecast function;
determining a forecast deviation value of the to-be-tested product at each test moment according to a difference value between the actual test performance value and the forecasted performance value of the to-be-tested product at each test moment;
determining a deviation forecast function according to the forecast deviation value of the to-be-tested product at each test moment based on the grey forecast model;
correcting the performance degradation forecast function by using the deviation forecast function; and
determining performance degradation failure time of the to-be-tested product based on the corrected performance degradation forecast function and a performance degradation failure threshold value of the to-be-tested product.

In an embodiment, as for the step of determining the performance degradation forecast function of the to-be-tested product according to the actual test performance value of the to-be-tested product at each test moment based on the gray forecast model, the processor is further configured to be capable of executing the computer program to: perform an accumulation calculation on an actual test performance value of the to-be-tested product at a test moment and actual test performance values of the to-be-tested product at other test moments before the test moment according to the grey forecast model, to obtain a performance transformation value of the to-be-tested product at the test moment; and determine a value of an unknown parameter in an initial performance degradation forecast function according to the performance transformation value and the actual test performance value of the to-be-tested product at each test moment, and obtain the performance degradation forecast function of the to-be-tested product.

In an embodiment, as for the step of determining the deviation forecast function according to the forecast deviation value of the to-be-tested product at each test moment based on the grey forecast model, the processor is further configured to be capable of executing the computer program to: perform an accumulation calculation on a forecast deviation value of the to-be-tested product at a test moment and forecast deviation values of the to-be-tested product at other test moments before the test moment according to the grey forecast model, to obtain a deviation transformation value of the to-be-tested product at the test time; and determine a value of an unknown parameter in the initial deviation forecast function according to the forecast deviation value and the deviation transformation value of the to-be-tested product at each test moment, and obtain the performance degradation forecast function of the to-be-tested product.

In an embodiment, the processor is further configured to be capable of executing the computer program to: determine a characteristic lifetime of the to-be-tested product under a target stress condition based on a general target acceleration model corresponding to the to-be-tested product; determine a reliability function of the to-be-tested product under the target stress condition based on the characteristic lifetime; and determine a reliability curve of the to-be-tested product based on the reliability function of the to-be-tested product under the target stress condition.

In an embodiment, the processor is further configured to be capable of executing the computer program to: acquire a stress magnitude of a reference product under each accelerated test during the accelerated test on the reference product under at least two different second stress conditions, in which the reference product is of the same type as the to-be-tested product; acquire an initial general acceleration model corresponding to the reference product, in which the initial general acceleration model includes a parameter to be solved; and solve the parameter to be solved in the initial general acceleration model based on the initial general acceleration model, the stress magnitude of the reference product under each accelerated test, and a type of the lifetime distribution function, and obtain the target general acceleration model.

In an embodiment, as for the step of acquiring the initial general acceleration model corresponding to the reference product, the processor is further configured to be capable of executing the computer program to: determine the initial general acceleration model from candidate general acceleration models according to a stress type of each second stress condition.

In an embodiment, the processor is further configured to be capable of executing the computer program to determine an average lifetime of the to-be-tested product based on the characteristic lifetime and the type of the lifetime distribution function.

It will be appreciated by those of ordinary skill in the art that all or a part of the procedures of implementing the methods in the above-mentioned embodiments may be accomplished by a computer program instructing a related hardware; the computer program may be stored in a non-transitory computer-readable storage medium, the computer program, when executed, may implement steps including the procedures in the embodiments of the method described above. Any reference to a memory, database, or other medium used in the embodiments provided herein may include at least one of non-transitory memory and transitory memory. The non-transitory memory may include Read-Only Memory (ROM), magnetic tape, floppy disk, flash memory, optical memory, high-density embedded non-transitory memory, resistive random access memory (ReRAM), Magnetoresistive Random Access Memory (MRAM), Ferroelectric Random Access Memory (FRAM), Phase Change Memory (PCM), graphene memory, and the like. The transitory memory may include a Random Access Memory (RAM) or an external cache memory or the like. By way of illustration and not limitation, the RAM may be in a variety of forms, such as Static Random Access Memory (SRAM) or Dynamic Random Access Memory (DRAM). The databases referred to in the embodiments provided herein may include at least one of a relational database and a non-relational database. The non-relational database may include a block chain-based distributed database or the like, and is not limited thereto. The processor involved in the embodiments provided herein may be a general purpose processor, a central processing unit, a graphics processor, a digital signal processor, a programmable logic unit, a quantum computing-based data processing logic unit, or the like, and is not limited thereto.

Each of the technical features in the above embodiments may be combined arbitrarily. For the sake of brevity, all possible combinations of each of the technical features in the above embodiments are not described. However, the combinations of these technical features should be considered to be within the scope of the present disclosure as long as they do not contradict each other.

The above-described embodiments merely provide some implementation modes of the present disclosure, which are described in more detail and detail, but are not therefore to be construed as limiting the scope of the patent disclosure. It should be noted that several transformations and improvements may be made by those of ordinary skill in the art without departing from the spirit and scope of the present disclosure. Accordingly, the scope of protection of the present disclosure should be subject to the appended claims.

1. An accelerated test data analysis method based on a grey forecast model, comprising:
acquiring an actual test performance value of a to-be-tested product at each test moment during an accelerated test of the to-be-tested product under a first stress condition;
determining a performance degradation forecast function of the to-be-tested product according to the actual test performance value of the to-be-tested product at each test moment based on the gray forecast model;
forecasting or obtaining a forecasted performance value of the to-be-tested product at each test moment based on the performance degradation forecast function;
determining a forecast deviation value of the to-be-tested product at each test moment according to a difference value between the actual test performance value and the forecasted performance value of the to-be-tested product at each test moment;
determining a deviation forecast function according to the forecast deviation value of the to-be-tested product at each test moment based on the grey forecast model;
correcting the performance degradation forecast function by using the deviation forecast function; and
determining performance degradation failure time of the to-be-tested product based on the corrected performance degradation forecast function and a performance degradation failure threshold value of the to-be-tested product;
wherein the determining the deviation forecast function according to the forecast deviation value of the to-be-tested product at each test moment based on the grey forecast model comprises:
for each test moment, performing an accumulation calculation on the forecast deviation value of the to-be-tested product at a test moment and the forecast deviation values of the to-be-tested product at other test moments before the test moment according to the grey forecast model, to obtain a deviation transformation value of the to-be-tested product at the test time; and
determining a value of an unknown parameter in the initial deviation forecast function according to the forecast deviation value and the deviation transformation value of the to-be-tested product at each test moment, and obtaining the deviation forecast function of the to-be-tested product.

2. The method according to claim 1, wherein the determining the performance degradation forecast function of the to-be-tested product according to the actual test performance value of the to-be-tested product at each test moment based on the gray forecast model comprises:
for each test moment, performing an accumulation calculation on an actual test performance value of the to-be-tested product at a test moment and actual test performance values of the to-be-tested product at other test moments before the test moment according to the grey forecast model, to obtain a performance transformation value of the to-be-tested product at the test moment; and
determining a value of an unknown parameter in an initial performance degradation forecast function according to the performance transformation value and the actual test performance value of the to-be-tested product at each test moment, and obtaining the performance degradation forecast function of the to-be-tested product.

3. (canceled)

4. The method according to claim 1, further comprising:
determining a characteristic lifetime of the to-be-tested product under a target stress condition based on a general target acceleration model corresponding to the to-be-tested product;
determining a reliability function of the to-be-tested product under the target stress condition based on the characteristic lifetime; and
determining a reliability curve of the to-be-tested product based on the reliability function of the to-be-tested product under the target stress condition.

5. The method according to claim 4, further comprising:
acquiring a stress magnitude of a reference product under each accelerated test by performing the accelerated tests on the reference product under at least two different second stress conditions, wherein the reference product is of the same type as the to-be-tested product;
acquiring an initial general acceleration model corresponding to the reference product, wherein the initial general acceleration model includes a parameter to be solved; and
solving the parameter to be solved in the initial general acceleration model based on the initial general acceleration model, the stress magnitude of the reference product under each accelerated test, and a type of a lifetime distribution function, and obtaining the target general acceleration model.

6. The method according to claim 5, wherein the acquiring the initial general acceleration model corresponding to the reference product comprising:
determining the initial general acceleration model from candidate general acceleration models according to a stress type of each second stress condition.

7. The method according to claim 5, further comprising:
determining an average lifetime of the to-be-tested product based on the characteristic lifetime and the type of the lifetime distribution function.

8. An accelerated test data analysis apparatus based on a grey forecast model, comprising a processor and a memory for storing instructions executed by the processor;
wherein the processor is configured to:
acquire an actual test performance value of a to-be-tested product at each test moment during an accelerated test of the to-be-tested product under a first stress condition;
determine a performance degradation forecast function of the to-be-tested product according to the actual test performance value of the to-be-tested product at each test moment based on the gray forecast model;
predict a forecasted performance value of the to-be-tested product at each test moment based on the performance degradation forecast function;
determine a forecast deviation value of the to-be-tested product at each test moment according to a difference value between the actual test performance value and the forecasted performance value of the to-be-tested product at each test moment;
for each test moment, perform an accumulation calculation on the forecast deviation value of the to-be-tested product at a test moment and the forecast deviation values of the to-be-tested product at other test moments before the test moment according to the grey forecast model, to obtain a deviation transformation value of the to-be-tested product at the test time, determine a value of an unknown parameter in the initial deviation forecast function according to the forecast deviation value and the deviation transformation value of the to-be-tested product at each test moment, and obtain the deviation forecast function of the to-be-tested product;
correct the performance degradation forecast function by using the deviation forecast function;
determine performance degradation failure time of the to-be-tested product based on the corrected performance degradation forecast function and a performance degradation failure threshold value of the to-be-tested product.

9. A computer device, comprising a processor and a memory storing a computer program, wherein the processor, when executing the computer program, implements the method of claim 1.

10. A computer-readable storage medium, on which a computer program is stored, wherein the computer program, when executed by a processor, causes the processor to implement the method of claim 1.
